(19) United States
(12) Patent Application Publication
(10) Pub. No.: US 2003/0182274 A1
(43) Pub. Date: Sep. 25, 2003

(54) Navigable search engine

(76) Inventor: Young-June Oh, South Perth (AU)

Correspondence Address: LARSON & TAYLOR, PLC, 1199 NORTH FAIRFAX STREET, SUITE 900, ALEXANDRIA, VA, 22314, US

(21) Appl. No.: 10/343,027

(22) PCT Filed: Jul. 27, 2001
(86) PCT No.: PCT/AU01/00927

(51) Int. Cl. G06F 17/30

(52) U.S. Cl. 707/3

(57) ABSTRACT

A navigable search engine architecture comprising a plurality of search look up tables (10) having predetermined search values selectable by a user to define a search criteria, a plurality of target directories (14) consisting of target items that a search may be targeted to find, each directory organised with multi-level nodes, the nodes at each level having a heading that identifies a common characteristic or the target items linked to that node and a plurality of target directory indices (16) that are employed by the search engine to navigate through the target directories, each target directory index providing a link between each of said nodes in the target directories and related search values provided in said look up tables. When a user has defined a search criteria using said search values, the search engine finds and lists (20) the headings of the nodes that are related to said search criteria.

### FIELD OF THE INVENTION

The present invention relates to a search engine that enables a user to navigate their way to a particular target of a search query and relates particularly, though not exclusively, to a search engine that facilitates navigable searching of the World Wide Web via the Internet.

### BACKGROUND TO THE INVENTION

Over the last decade there has been an explosion of information available in electronic form via the Internet. The new possibilities for doing business via the Internet, so-called e-commerce, have resulted in a further proliferation of websites as individuals, corporations and other associations create a presence for themselves in the electronic marketplace. Whilst this has facilitated enhanced accessibility and greater consumer choice for those with access to the Internet, it has also made it correspondingly more difficult for users of the Internet to locate a particular website, product or other information of interest, as the number of potentially relevant listings has increased exponentially. There is therefore a need for Internet users to be provided with search facilities that enable them to locate relevant information more readily. A number of search engines are available for this purpose, including the larger search engines such as YAHOO (www.yahoo.com) and LOOKSMART (www.looksmart.com).

One of the disadvantages of the large search engines and directories is that a search query typically produces a very large number of listings, and the user must then scroll through each page of listings in order to locate the relevant items. This is very tedious and frustrating as the user is forced to examine mostly irrelevant information. This problem is the result of the way in which all of the major search engines structure the information in their directories. They all employ the same basic architecture, namely a monolithic hierarchical tree structure with many branches for different categories of information, similar to the way in which the Yellow Pages telephone directory is organised. As the number of listings grows, the tree becomes disproportionately larger and larger as more and more branches are added. There is a further significant disadvantage of this type of architecture, namely, the large number of editors required in a centralised organisation to maintain the directory information up to date. The way in which the directory structure is organised means that multiple entries have to be made each time a new listing is added to the directory. Maintaining the directory therefore becomes a mammoth task.

Recently, some smaller search engines, such as WHEREWITHAL (www.wherewithal.com) claim to provide a more efficient search service by providing a non-fixed taxonomy web directory. However, it appears such alternative search engines are still based on a similar hierarchical architecture as the more established search engines and directory services.

Other search engine developers have been attempting to address some of these shortcomings by enhancing the capabilities of web browsers. For example, modal-based search software “learns” from previous searches and is designed to better identify the type of result the user is looking for. One of the disadvantages of this type of software is that users are required to complete user and content profiles which then have to be “taught”.

None of the above prior art approaches to improving search engine performance address the fundamental problem with current search engine technology, which is the underlying monolithic hierarchical tree structure of the search directories.

### SUMMARY OF THE INVENTION

The present invention was developed with a view to providing a search engine that employs a fundamentally different architecture in order to facilitate more accurate retrieval of information in response to a search query.

Throughout this specification the term “comprising” is used inclusively, in the sense that there may be other features and/or steps included in the invention not expressly defined or comprehended in the features or steps subsequently defined or described.

What such other features and/or steps may include will be apparent from the specification read as a whole.

Whilst the present invention will be described with particular reference to searching the World Wide Web via the Internet, it will be understood that the search engine has wider application and can be used for searching databases, libraries of information, Yellow Pages directories, product catalogs, stock control databases and other large repositories of information stored in electronic format.

According to one aspect of the present invention there is provided a navigable search engine architecture comprising:

a plurality of search look-up tables of predetermined search values that can be selected by a user to define search criteria;

a plurality of search target directories which consist of target items that a search may be targeted to find, each directory being organised with multi-level nodes, the nodes at each level having a heading that identifies a common characteristic of the target items linked to that node; and,

a plurality of target directory indices that are employed by the search engine to navigate through the target directories, each target directory index providing a link between each of said nodes in the target directories and related search values provided in said search look-up tables;

whereby, in use, when a user has defined the search criteria using said search values the search engine finds and lists the headings of the nodes in the target directories that are related to said search criteria, wherein the user can then select a heading to find individual target items that fit the search criteria.

According to another aspect of the present invention there is provided a method of using a search engine to navigate to a particular target in response to a search query, the method comprising:

providing a plurality of search target directories which consist of target items that a search may be targeted to find, each directory being organised with multi-level nodes, the nodes at each level having a heading that identifies a common characteristic of the target items linked to that node;

searching through a plurality of target directory indices to locate relevant nodes in the target directories, each target directory index providing a link between each of the nodes in the target directories and related search values that may be selected by the user from a plurality of search look-up tables; and,

listing the headings of the nodes in the target directories that are related to said search values, wherein the user can then select a heading to find individual target items that fit the search criteria.

Preferably the search engine uses the search values and indices to create a directory list that lists all of the nodes in the target directories that are linked to the selected search values.

Preferably each said target directory is provided with the nodes and individual target items organised into a hierarchical tree structure wherein each node has a plurality of target items or other nodes linked to it. Typically each node and target item is provided with a unique identifier, and each target directory is provided with a target directory link table in which the links between “parents” and “children” within the hierarchical tree structure are defined using said identifiers.

According to a further aspect of the present invention there is provided a search engine comprising:

means for selecting one or more search values from a plurality of search look-up tables of predetermined search values to define search criteria;

means for selecting one of a plurality of search target directories which consist of target items that a search may be targeted to find, each directory being organised with multi-level nodes, the nodes at each level having a heading that identifies a common characteristic of the target items linked to that node;

means for defining a plurality of target directories indices that are employed by the search engine to navigate through the target directories, each target directory index providing a link between each of said nodes in the target directories and related search values provided in said search look-up tables; and,

means for finding and listing the headings of the nodes in the target directories that are related to search criteria defined by a user using said search values, wherein the user can then select a heading to find the individual target items that fit the search criteria.

According to a still further aspect of the present invention there is provided a computer software program arranged, when loaded in a computer, to instruct the computer to operate in accordance with a search engine comprising:

means for selecting one or more search values from a plurality of search look-up tables of predetermined search values to define search criteria;

means for selecting one of a plurality of search target directories which consist of target items that a search may be targeted to find, each directory being organised with multilevel nodes, the nodes at each level having a heading that identifies a common characteristic of the target items linked to that node;

means for defining a plurality of target directories indices that are employed by the search engine to navigate through the target directories, each target directory index providing a link between each of said nodes in the target directories and related search values provided in said search look-up tables; and,

means for finding and listing the headings of the nodes in the target directories that are related to search criteria defined by a user using said search values, wherein the user can then select a heading to find the individual target items that fit the search criteria.

### BRIEF DESCRIPTION OF THE DRAWINGS

In order to facilitate a more comprehensive understanding of the nature of the invention, a preferred embodiment of the navigable search engine will now be described in detail, by way of example only, with reference to the accompanying drawings, in which:

FIG. 1 illustrates the basic architecture of a preferred embodiment of the search engine in accordance with the present invention;

FIG. 2 illustrates the manner in which the data is organised in the search engine of FIG. 1;

FIG. 3 illustrates a typical graphical user interface (GUI) for the search engine of FIG. 1;

FIG. 4 illustrates three sample search look-up tables as they may typically appear on screen to a user, and,

FIG. 5 illustrates a preferred process of converting a conventional monolithic directory structure into a preferred search engine architecture according to the present invention

### DETAILED DESCRIPTION OF PREFERRED EMBODIMENT

All the popular search engines attempt to classify and organise the information accessible via the Internet in some manner. For example, Yahoo, Inc manually categories web sites using 14 broad headings and 20,000 different sub-headings. Within each broad category heading the information is organised hierarchically using a tree structure. However, there is an inherent limitation with this type of directory architecture. Typically, each time a new web site is added to the directory structure, multiple entries must be made because the information available at that web site can be categorised within multiple broad categories. Furthermore, separate entries must be made for each of the numerous sub-headings that may be relevant to that particular web site or piece of information. The directory structure is like a Yellow Pages telephone directory, in which the same business may have multiple listings in multiple index categories of-the directory. The sheer volume of work required to manually index every web site and piece of information in all of the appropriate categories and under all the relevant sub-headings means that this type of directory structure eventually becomes unmanageable for the search engine provider.

Prior art search engines can also be extremely frustrating to the end users because there is no effective way of surfing or navigating the vast amount of information from numerous sources using the current monolithic directory/sub-directory structure and keyword indexing system. With current search engine technology, when the user types in one or more keywords a large list of directory nodes and/or a list of web sites containing references to combinations of these keywords is produced. Because the directory tree structure is monolithic there is no facility to navigate to entries or web sites of particular interest, other than by drilling down through the directory and subdirectories until the desired information is located. If no relevant entries are found it is necessary to return to the beginning of the search and try a different combination of keywords. It is virtually impossible to search for information from the unique perspective of the individual user, since the information in the directory is of necessity organised using generic classification categories and indexing criteria.

The search engine of the present invention is based on a fundamentally different architecture in which the search categories or criteria, which are essentially static, are separated from the directory information, which is generally dynamic and constantly updated. The two are preferably linked using an indexing system that greatly simplifies the speed and accuracy of information retrieval. This inherently different taxonomy greatly enhances the navigable search engine's functionality. Furthermore it facilitates both vertical (different sources of information) and horizontal (different types of information) navigation of the directory information in such a way that each search can be customised by the user to suit their needs and modified as the search progresses without having to restart the search process.

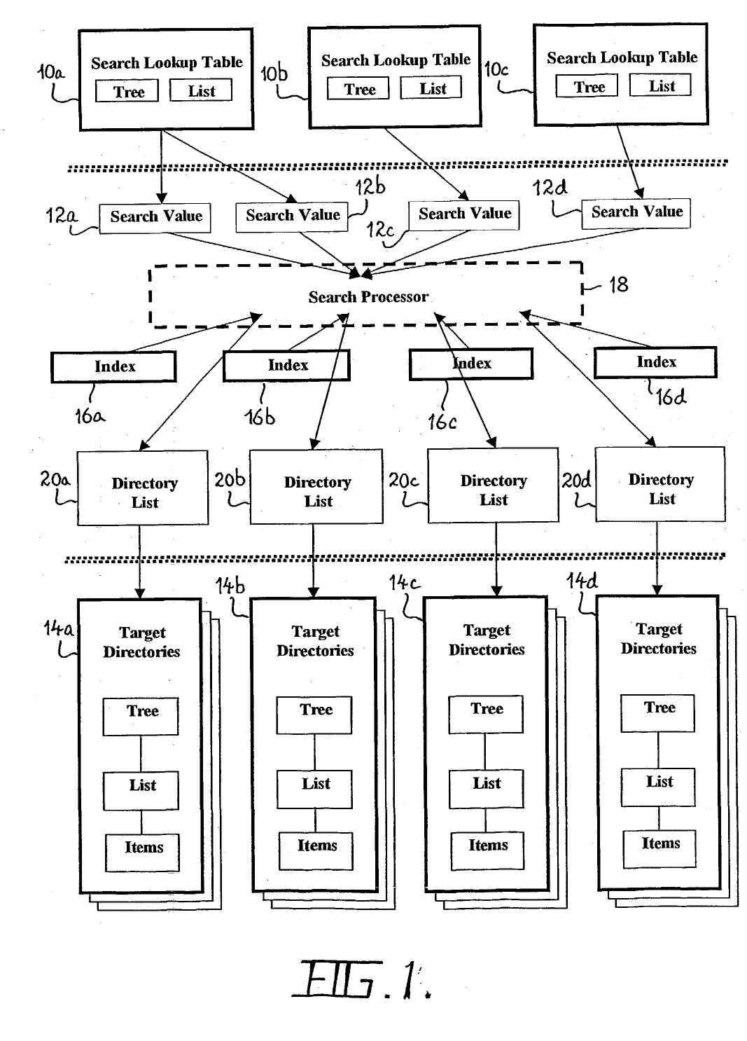

A typical embodiment of a navigable search engine in accordance with the present invention is illustrated in the accompanying drawings. FIG. 1 illustrates the basic architecture or data processing model of the search engine. A basic principle of the search engine is the manner in which the search engine architecture has been separated into two distinct sets of components. The first basic components are search look-up tables, which are static components that remain essentially unchanged, by which a user can specify exactly a search query using the appropriate search values. The second basic components are search target directories, which are dynamic components that can change on a daily basis, each target directory typically being a database of searchable target items organised into a directory structure. By defining these two sets of components independently of each other the architecture of the search engine is significantly simplified compared to prior art search engines and the ability to navigate the search engine is facilitated. Furthermore, as each look-up table is preferably independent of the others, a user can specify any combination of search values from the look-up tables independently of the target directories. The search engine can then find searchable target items in the target directories that satisfy the combination specified. This contrasts with prior art search engines in which the user himself must “drill down” through the directory in order to locate a desired combination, if it exists in the hierarchical tree structure of the directory.

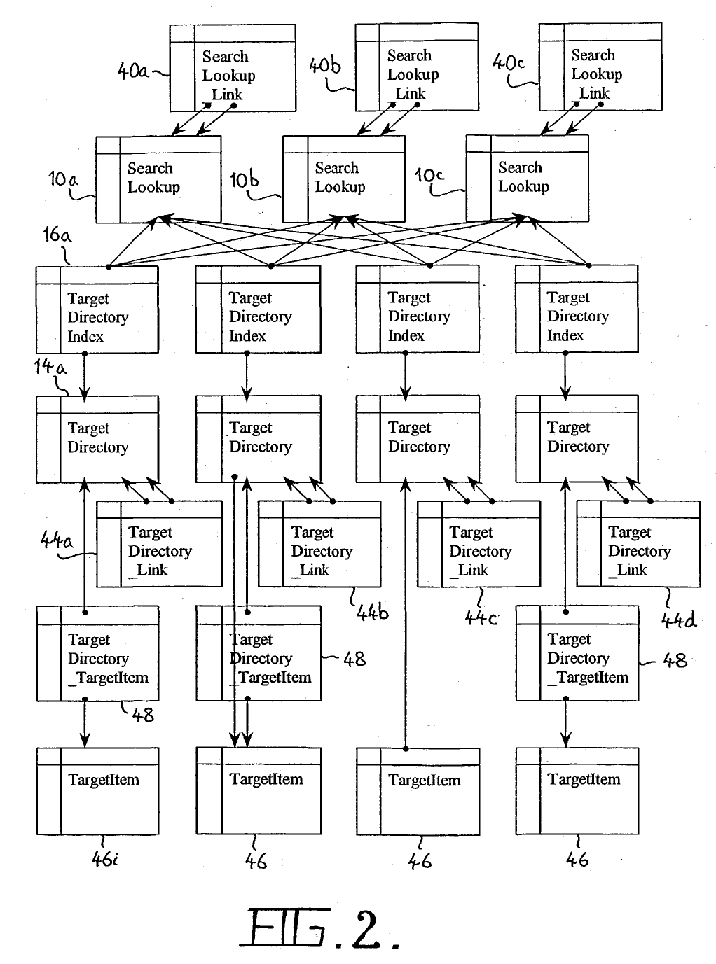

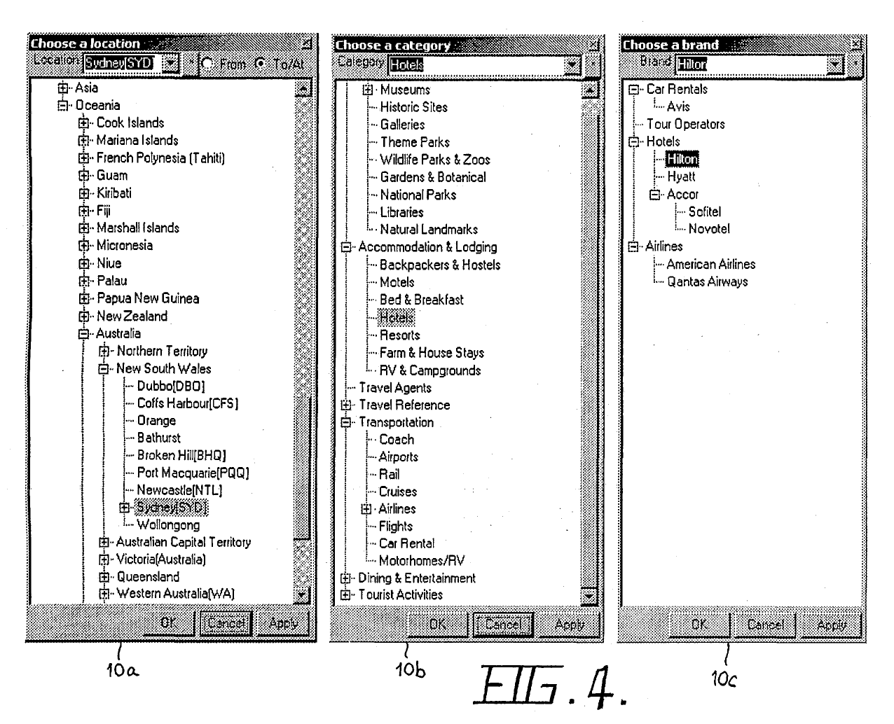

Predetermined search values are provided in each search look-up table, from which the appropriate search values can be selected by a user to define the search criteria. In FIGS. 1 and 2, three such search look-up tables 10a, 10b and 10c are illustrated schematically, however it will be understood that any number of such search look-up tables could be provided in practice. FIG. 4 illustrates the search look-up tables 10a, 10b and 10c as they might appear to a user on screen. For the purposes of illustration, search look-up table 10a lists search values relating to “Location”, table 10b lists search values relating to “Category”, and search look-up table 10c lists search values relating to “Brand”. If desired, a search look-up table may be employed to define more than one search value. For example, table 10a (Location) may be used to define both departure (from) location 12a and destination (to) location 12b, if the searcher wishes to search for available transportation options between the two locations. Search value 12b is also used to define the actual (at) location of a searchable target item.

The user defines the search criteria by selecting the appropriate search values from the search look-up tables. For example, if the user wishes to find out what flights are available from Los Angeles to Sydney, he will select “Los Angeles” for search value 12a, “Sydney” for search value 12b and “flights” for search value 12c. Alternatively, if he wishes to find out about Hilton Hotels in Sydney, he can select “Sydney” for search value 12b, “hotels” for search value 12c and “Hilton Hotels” for search value 12d.

The searchable target items are organised into a plurality of groups of search target directories 14a, 14b, 14c and 14d. Each target directory typically has a plurality of target items of a particular type organised into a tree structure with multi-level nodes. The nodes at each level of the tree have a heading that identifies a common characteristic of the target items linked to that node. Each group of search target directories consists of one or more target directories of a particular type of target item. Thus, in the illustrated embodiment target directories 14a may be directories of websites, target directories 14b may be directories of products, target directories 14c may be directories of bulletin boards, and target directories 14d may be directories of advertising. There would typically be a plurality of directories within each type that may, for example, be sourced from different suppliers. Thus, for example, target directories 14a may include a directory of websites supplied by Qantus Airways and entitled Qantus Hotel Guide which includes a section for Sydney, as well as a target directory of websites entitled “Sydney Hotel Guide” supplied by the NSW Tourism Commission. Some sample data for a target directory of websites entitled “Sydney Hotel Guide” is given below:

```
Sydney Hotel Guide
  By Star Rating
    Five Stars
      Sydney Hilton Hotel
  By Location
    City Center
      Sydney Hilton Hotel
  By Rate
    Less than $200
    More than $200
      Sydney Hilton Hotel
```

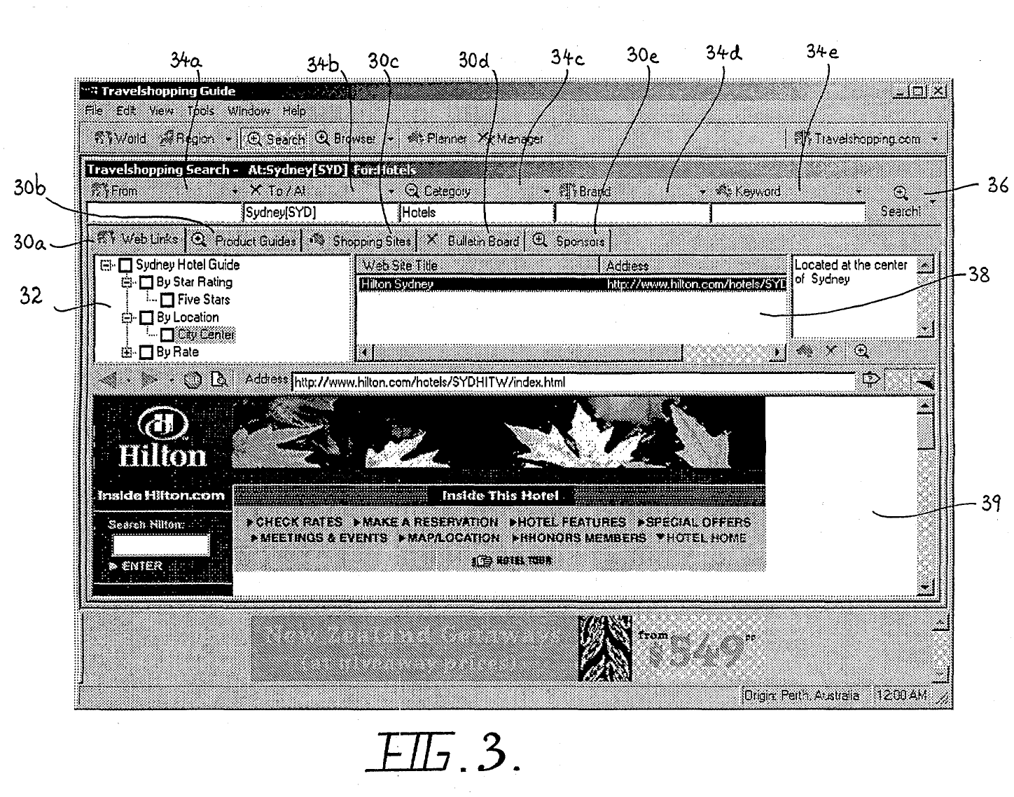

In the above sample data, the tree structure of the directory has been partly expanded to reveal one of the target items, in this case “Sydney Hilton Hotel”. This target item is linked to three separate nodes with the headings “Five Star”, “City Center” and “More than $200”. These three nodes are themselves linked to three further nodes on the next level up, namely nodes with the headings “By Star Rating”, “By Location”, “By Rate”. With the example given above, of a user wishing to find out about Hotels in Sydney, the headings of all the nodes given above would have been listed in the search result, in a format similar to that illustrated in the search window 32 of the GUI in FIG. 3.

The way in which the target directories 14 are organised and produced will be described in further detail below.

The user typically defines the type of target directories they wish to view, as well as the search values that specify more particularly what the user is looking for, prior to the commencement of search processing. For this purpose, the graphical user interface (GUI) of the search engine has a number of buttons 30, (see FIG. 3) one of which the user must press prior to commencement of the search. Thus, if the user is trying to find the address for a particular target website, he must press button 30a and the search engine will produce a list of headings in target directory 14a (websites) from which the user can then select a particular heading to find a specific website that fits his search criteria. Alternatively, if the user wishes to find a particular product, he must press button 30b and the search engine will produce a list of headings from the target directory 14b (products).

In order to link the search values provided in the look-up tables 10 with the target items in the target directories 14, the search engine also provides a plurality of target directory indices that are used to navigate through the target directories. Each target directory 14 is provided with its own index 16 as shown in FIG. 1. Each index 16 provides a link between each of the nodes in the corresponding target directory and related search values provided in the search look-up tables 10. In use, when a user has defined the search criteria using selected search values from the look-up tables 10, the search engine finds and lists the headings of all of the nodes in the target directory that are related to the search criteria. The user can then select and expand a heading to find individual target items that fit the search criteria.

When the user has selected the appropriate search values 12, a search processor 18 searches the appropriate directory index 16 for the selected search values and creates a directory list 20. Whereas the target directories 14 and corresponding indices 16 are enduring features of the search engine, the directory lists 20 are transient or temporary and only exist for the duration of the search request. Thus, for example, if the selected search values are “Sydney [SYD]” and “Hotels”, the search processor 18 will search index 16a to create a directory list 20a that consists, for example, of “Sydney Hotel Guide” as in the example described above. This list is then used to display the search result in a format similar to that illustrated in window 32 of the GUI in FIG. 3.

Whilst the search look-up tables 10 are static and remain substantially unchanged, the target directories 14 are dynamic and can change on a daily basis. The target directories 14 are typically provided by the relevant industry service or product providers. For example, different accommodation listings may be provided by private travel organisations, or each State Tourist Commission, already produced in the appropriate target directory format for the search engine. The corresponding index is also typically created by the supplier of the directory, and can be controlled manually to create all of the appropriate links between each of the nodes in the directory and related search values provided in the search look-up tables. Each supplier of target directories is provided with proprietary software needed to create the target directory index in the appropriate format. The advertising target directory 14d of the illustrated embodiment, provides another feature which is unique to the preferred embodiment of the search engine according to the present invention, namely the ability to target advertising based on the search criteria selected by the user. At present, most advertising over the Internet is by way of so-called banner ads, which may be static or animated, and which appear below the top border or just above the bottom border of the screen. Other forms of advertising over the Internet, using currently available technology, include short video clips or animated advertisements which appear in a small window displayed on the screen. Using the search engine of this embodiment, advertisers can pay to have their advertisements listed in the target directory 14d with its corresponding index 16d that links the advertisements to related search values provided in the search look-up tables 10. Sample data for the advertising target directory 14d are listed below:

```
Los Angeles to Sydney, Flights
    Qantas Airways Banner Ad
    American Airlines Banner Ad
Sydney, Hotels
    Hilton Hotels Banner Ad
    Hyatt Hotels Video Clip Ad
Sydney, Golf
    Visa Card Animation Ad
```

Thus, in the above example, if the user has selected “Los Angeles” for search value 12a, “Sydney” for search value 12b and “flights” for search value 12c, the search engine automatically detects that there are two banner ads listed in its target directory 14d, namely a banner ad for Qantas Airways and a banner ad for American Airlines, both of which offer flights between Los Angeles and Sydney. Both Qantas Airways and American Airlines have paid to have their advertisements appear on screen when these search values are nominated. The duration and manner in which each banner ad is displayed will be a function of the basis on which advertising space is sold. It will be seen that this feature of the preferred search engine provides a significant advantage over prior art search engines as particular vendors' advertising can be targeted to selected end users, rather than simply displayed at random as in prior art search engines.

The way in which the data is preferably organised in the search engine according to a relational data structure will now be described with reference to FIG. 2. Each search look-up table 10 has a search look-up link table 40 associated therewith. The purpose of the search look-up link tables 40 is to define the links between each of the search values in the associated search look-up table, so that the search values in the associated look-up table can be organised into a hierarchical tree structure. Sample search values and links are provided in Tables 1a and 1b respectively for the search look-up table 10a “Location”.

TABLE 1a
Search Lookup - Location

| Location Id | Location Name |
|---|---|
| 1 | All |
| 101 | World |
| 102 | Oceania |
| 103 | Australia |
| 104 | New South Wales |
| 105 | Sydney[SYD] |

TABLE 1b
Search Lookup_Link - Location

| Location Id | Location Id |
|---|---|
| Parent | Child |
| 101 | 102 |
| 102 | 103 |
| 103 | 104 |
| 104 | 105 |

In Table 1a, each search value has been given an alphanumeric identifier, and these identifiers are then used to define the “parent/child” relationship between each of the search values in the associated link table. In FIG. 4, Table 10a has been expanded to show the links defined in Table 1b in order to create the illustrated hierarchical tree structure. As can be seen from table 10a in FIG. 4, Oceania is linked as a parent to Australia, which is in turn linked as a parent to New South Wales, which is in turn linked as a parent to Sydney. By defining the search look-up tables in this manner, all of the search values can be listed either in alphabetical order, or according to this hierarchical tree structure to enable the user to navigate down to the desired location by expanding the tree as required. It will be understood that the search look-up tables can be expanded to include additional search values as required. For example, each of the cities listed in New South Wales could in turn be linked as parents to particular suburbs in each of the cities. If desired, each of the suburbs could be linked as parents to particular street names, and so on. Tables 2a and 2b and Tables 3a and 3b below provide sample search values and link tables respectively for the “category” and “brand” search look-up tables.

TABLE 2a
Search Lookup - Category

| Category Id | Category Name |
|---|---|
| 1 | All |
| 101 | Travel |
| 102 | Accommodation |
| 103 | Hotels |
| 104 | Transportation |
| 105 | Flights |

TABLE 2b
Search Lookup_Link - Category

| Category Id | Category Id |
|---|---|
| Parent | Child |
| 101 | 102 |
| 102 | 103 |
| 101 | 104 |
| 104 | 105 |

TABLE 3a
Search Lookup - Brand

| Brand Id | Brand Name | CanSelect |
|---|---|---|
| 1 | All | No |
| 101 | Travel | No |
| 102 | Accommodation | No |
| 103 | Hilton Hotels | Yes |
| 104 | Hyatt Hotels | Yes |
| 105 | Airlines | No |
| 106 | Qantas Airways | Yes |
| 107 | American Airline | Yes |

TABLE 3b
Search Lookup_Link - Brand

| Brand Id Parent | Brand Id Child |
|---|---|
| 101 | 102 |
| 102 | 103 |
| 102 | 104 |
| 101 | 105 |
| 105 | 106 |
| 105 | 107 |

Table 3a, the search look-up table for “Brand”, includes an additional column headed “Can Select” which simply specifies whether or not the search value listed can be selected by the user for searching purposes. It will be seen that each of the search values listed in Table 3a which cannot be selected do not relate to particular brands. They are included in the search look-up table 3a simply to facilitate organisation of the search values into a hierarchical tree structure.

The FIG. 2, each of the lines linking the tables is intended to indicate the relationship between the tables based on a standard convention in relational database modelling. An arrowhead on the link represents “one part”, whereas a “dot” represents “many parts”. Hence, a line with a dot at one end and an arrowhead at the other represents a “one to many” relationship.

Each of the target directories 14 is also provided with an associated target directory link table 44. The purpose of the target directory link tables 44 is to define the parent/child relationship between each of the nodes in the associated search target directory 14, so that the nodes can be organised according to a hierarchical tree structure as previously described. Tables 4a and 4b below provide sample data for the search target directory 14a of websites for Sydney hotels and it's associated target directory link table 44a.

TABLE 4a
Target Directory - Web Links

| LinkNode Id | Name |
|---|---|
| 101 | Sydney Hotel Guide |
| 102 | By Star Rating |
| 103 | Five Stars |
| 104 | By Location |
| 105 | City Center |
| 106 | By Rate |
| 107 | Less Than $200 |
| 108 | More Than $200 |
| 109 | Metropolitan Area |

TABLE 4b
Target Directory Link - Web Links

| LinkNode | LinkNode |
|---|---|
| Id Parent | Id Child |
| 101 | 102 |
| 102 | 103 |
| 101 | 104 |
| 104 | 105 |
| 101 | 106 |
| 106 | 107 |
| 106 | 108 |
| 104 | 109 |

Each of the search target directories 14 also has an associated target directory index 16 as described above. The index provides a link between each of the nodes in the corresponding target directory and related search values provided in the search look-up tables 10. Table 5 below provides sample data for the target directory index corresponding to the target directory 14a (web links). In this example, only the links between selected search values and the node headed “Sydney Hotel Guide” (link node ID 101 in Table 4a) are provided. Thus, for example, the first line in Table 5 indicates that link node ID 101 (Sydney Hotel Guide) is linked to location ID-from 1 (All), location ID-To/At 105 (Sydney [SYD]), category ID 102 (Accommodation) and brand ID 1 (All). A user may select this combination of search values if they are interested in all types of accommodation, irrespective of brand, located at Sydney. It will be appreciated that the target directory index may be quite large in order to define the links between each of the nodes in the corresponding target directory and the numerous combinations of possible search values that may be linked to each node. Table 5 only lists four such links for one particular node. There would be other links for the same node that have not been listed in Table 5, and all of the links for each of the other nodes in the corresponding target directory have also been omitted for simplicity.

TABLE 5
Target Directory Index - Web Links

| | Location Id | Location Id — | | |
|---|---|---|---|---|
| LinkNode Id | -From | To/At | Category Id | Brand Id |
| 101 | 1 | 105 | 102 | 1 |
| 101 | 1 | 105 | 103 | 1 |
| 101 | 1 | 104 | 102 | 1 |
| 101 | 1 | 104 | 103 | 1 |

As noted above, the same target item may be linked to several nodes in the one target directory. Table 6 below lists sample target items, in this case the websites for the Sydney Hilton Hotel (site ID 101) and the Sydney Golf Resort (site ID 102). In the example given above, the Sydney Hilton Hotel is linked to three separate nodes, namely, “Five Stars” (link node ID 103 in Table 4a), “City Center” (link node ID 105) and “More than $200” (link node ID 108). These individual target items are illustrated at 46 in FIG. 2. A target directory—target item link table 48 is provided for each of the target directories 14 in order to define the links between the target items and the nodes of the corresponding target directory. Table 7 below provides sample data defining the links between the target item “Sydney Hilton Hotel” (site ID 101 in Table 6) with each of the nodes listed in Table 4a to which it is linked.

TABLE 6
Target Item - Web Sites

| Site Id | Site Name |
|---|---|
| 101 | Sydney Hilton Hotel |
| 102 | Sydney Golf Resort |

TABLE 7
Target Directory_Target Item-Web Links

| LinkNode Id | Site Id |
|---|---|
| 103 | 101 |
| 105 | 101 |
| 108 | 101 |

The manner in which the search engine typically processes a search query will now be described using the sample data given in Tables 1 to 7 above.

The user wishes to find the websites of hotels in Sydney, irrespective of brand. Therefore, using the GUI of FIG. 3 the user selects the appropriate search values from each of the search look-up tables 10. By pressing on the “To/At” button 34b the search look-up table 10a is opened to enable her to select a location. In Table 10a in FIG. 4 “Sydney[SYD]” has been highlighted to indicate the user's selection. She then presses button 34c to select a category of searchable items from the search look-up table 10b as shown in FIG. 4 in which “hotels” has been selected. If no selection of search values using the “From” button 34a and the “Brand” button 34d are made, the default search value “all” is automatically selected. Then she will press the web links button 30a which indicates to the search engine which of the search target directories to employ in the search. The user then presses the search button 36 to commence the search processing.

The search engine then searches through the indices 16 for each of the target directories 14a of websites in order to locate those nodes within the target directories linked to the selected search values. Therefore in Table 5 above it will find link node ID 101 is linked to the specified combination of search values (1/105/103/1). It then begins to build a target directory list 20 using the links defined in Tables 4b and 7. From Table 4b it finds that link node ID 101 is linked as a parent to link nodes ID 102, 104 and 106 in Table 4a.

Hence, it will list each of these nodes in the target directory list. The target directory list will also include the sub-nodes 103, 105, 107 and 108 which are linked as children to the link nodes 102, 104 and 106. The search engine then displays the headings for each of the nodes 102, 104 and 106 in the search window 32 in FIG. 3. The user can then select which of these nodes she wishes to expand by clicking on the appropriate icons. In this way the user can navigate through the directory list to locate only those items of interest, without having to view all of the target items in one listing. In FIG. 3, the sub-node “City Center” has been selected, which according to Table 4a has the link node ID 105. From Table 7, the search engine finds that link node ID 105 is linked to website 101 (Sydney Hilton Hotel). The title of this website and the URL are displayed in window 38. In this simplified example, the website for only one hotel located at the centre of Sydney is displayed. However, in reality a number of website titles and addresses would typically be listed from which the user can select a particular website. When the user selects a particular website, the search engine retrieves the home page for the Sydney Hilton Hotel and displays this in the window 39. The user can then check hotel rates, make a hotel reservation or search the Hilton website according to the search capabilities of the website.

Recently, there has been a trend towards the creation of corporate portals or industry specific portals, which provide access to the various departments or services of a company, or members of an industry organisation. The search engine architecture of the present invention is readily adapted to a corporate or intranet portal environment, allowing both internal and external users of the portal to easily navigate a path to the desired department, service or other source of information. Furthermore, by linking at least some of the same predetermined search values in the search look-up tables of the corporate portal search engine, the portal can be readily linked to a centralised global search engine. The company may then elect to keep all its target directories stored locally rather than centrally with the global search engine. Alternatively, it may elect to transfer all its target directory information to the centralised global search engine server. This feature is only possible because the target directories are separated from the search look-up tables in the search engine of the invention. It therefore facilitates a distributed architecture for the search engine which is just not feasible with conventional search engines. The manner in which the search engine architecture of the present invention can be adapted to provide distributed searching will be described below.

In the above described example, it was assumed that all of the target directories are stored on one server. However, the navigable search engine architecture of the preferred embodiment can be readily modified to accommodate a distributed search facility. With thus facility, target directories may be stored on a plurality of remotely located servers but may still be searched by the search engine in a manner that is opaque to the user. The search engine architecture on the remotely located servers must be similar to that of the main server, ie, with search look-up tables separated from the search target directories. However, the distributed searching facility can be achieved even if the search values employed in the search look-up tables in the remotely located servers are different from the search values employed in the search look-up tables on the main server. In order to illustrate a distributed search architecture, the above-described example will be expanded to include search target directories located on a number of remotely located servers. Table 8 is a list of websites together with the name of the respective server on which the website is maintained. Each server is given a Server Id No. It is assumed that the directory information stored on each of the servers, and which is accessible via the website, is organised in accordance with the navigable search engine architecture described above.

TABLE 8
Server List

| Server Id | Server Name | Url |
|---|---|---|
| 1001 | MainServer.com | www.mainserver.com |
| 1002 | Sydney.com | www.sydney.com |
| 1003 | BlueMountain.com | www.bluemountain.com |
| 1004 | HunterValley.com | www.huntervalley.com |

On page 7 above, some sample data for a target directory of websites entitled “Sydney Hotel Guide” was given. Let us now assume that there are now several distributed target directories which are located on several remote servers as listed Table 8 above. To the user, the distributed directories will appear as a single integrated directory. The integrated directory using three levels of distributed servers can be presented as follows:

Sydney Hotel Guide (www.mainserver.com)
By Location (www.mainserver.com)
Metropolitan Area (www.mainserver.com)
Sydney Hotel Directory (www.sydney.com)
Sydney North Area (www.sydney.com)
Hunter Valley Hotel directory
(www.huntervalley.com)
Sydney South Area (www.sydney.com)
Sydney West Area (www.sydney.com)
Blue Mountain Hotel Directory
(www.bluemountain.com)
Royal Blue Mountain Hotel
Hotel Blue Mountain

This particular distributed directory structure relates to the Sydney Hotel Guide organised By Location identified by LinkNode Id 104 in Table 4a. From Table 4b it will be seen that LinkNode Id parent 104 is linked to LinkNode Id Child 109, which from Table 4a is the target directory-weblink for the Metropolitan Area. In this illustrated example, as can be seen from Table 9 below, let us assume that the Metropolitan Area (LinkNode Id 109) target directory is linked to several remotely located distributed target directories within the Sydney Metropolitan Area, including the Sydney Hotel Directory (LinkNode Id 2001) which resides on the sydney.com server (server Id 1002). Table 10a lists the Sydney.com Target Directory-Weblinks with their corresponding LinkNode Id numbers. Table 10b is the associated Target Directory Link table for the Sydney.Com Target Directory-Weblinks.

TABLE 9
MainServer.com Target Directory Server Links

| LinkNode Id | Server Id | Linked LinkNode Id |
|---|---|---|
| 109 | 1002 | 2001 |

TABLE 10a
Sydney.com Target Directory - Web Links

| LinkNode Id | Name |
|---|---|
| 2001 | Sydney Hotel Directory |
| 2002 | Sydney North Area |
| 2003 | Sydney South Area |
| 2004 | Sydney West Area |
| 2005 | Sydney Hotel Guide (mainserver.com) |

TABLE 10b
Sydney.com Target Directory_Link - Web Links

| LinkNode | LinkNode |
|---|---|
| Id Parent | Id Child |
| 2001 | 2002 |
| 2001 | 2003 |
| 2001 | 2004 |
| 2001 | 2005 |

From Table 10b it will be seen that Sydney North Area, Sydney South Area, Sydney West Area and Sydney Hotel Guide are all linked as children to the Sydney Hotel Directory as parent. The distributed directory structure described thus far has two levels, namely, the main server.com server (server Id 1001) and the sydney.com server (server Id 1002). For illustrative purposes, a third level of distributed target directories is provided at he bluemountain.com server (server Id 1003) and the huntervalley.com server (server Id 1004). For simplicity, only the bluemountain.com server will be discussed at this third level. Table 11 below lists the server links at this third level for the sydney.com target directory.

TABLE 11
Sydney.com Target Directory Server Links

| LinkNode Id | Server Id | Linked LinkNode Id |
|---|---|---|
| 2004 | 1003 | 5001 |
| 2005 | 1001 | 101 |

TABLE 12
BlueMountain.com Target Directory - Web Links

| LinkNode Id | Name |
|---|---|
| 5001 | Blue Mountain Hotel Directory |

As can be seen from Table 11, the bluemountain.com server (server Id 1003) is linked to the Sydney West Area directory (LinkNode Id 2004). The Blue Mountain Hotel Directory (LinkNode Id 5001—see Table 12) is found on the bluemountain.com server 1003. Also, Sydney Hotel Guide (LinkNode Id 2005) points back to the mainserver.com server (server Id 1001) to make the server link bi-directional. Hence, if the user logs on to the sydney.com server (Server Id 1001) and clicks on the Sydney Hotel Guide (mainserver.com), the system takes her back to the higher level listing of the Sydney Hotel Guide (www.mainserver.com) (LinkNode Id 101) via server LinkNode Id 2005.

With the above distributed directory structure, weblinks for hotels in the Blue Mountains district of the Sydney West Area can be retrieved seamlessly by the search engine and presented to the user of the mainserver.com server as a single integrated directory presentation. Significantly, each of the distributed servers can create its own look-up tables with search values that are quite independent from the search values employed in the search look-up tables of the central server. Preferably technologies implementing extensible mark up language (XML) are employed for data communication which greatly enhances the operability of the distributed directory system. It will be seen that with this approach, the number of searchable directories can be expanded indefinitely, without compromising the speed of the search or the accuracy of the information retrieved. The distributed directory architecture described facilitates seamless navigation of the search engine across the entire web, not just within a particular server.

The above described system of searching distributed directories relies on the linking of the distributed directories with suitable link tables. However, another approach that may be employed for searching distributed directories in an integrated manner is based on the search look-up tables. As each server has its own look-up tables, it is possible to provide a centralised look-up routing table to link the search items in each of the look-up tables located at the remote servers. Thus, for example, Table 13 illustrates the search look-up table for search values relating to “Category” on the sydney.com server, whereas Table 14 lists the search values in the search look-up tables relating to “Category” on the bluemountain.com server.

TABLE 13
Sydney.com Search Lookup - Category

| Category Id | Category Name |
|---|---|
| 1 | All |
| . | |
| . | |
| . | |
| 502 | Accommodation |
| 503 | Hotel |

TABLE 14
BlueMountain.com Search Lookup - Category

| Category Id | Category Name |
|---|---|
| 1 | All |
| . | |
| . | |
| . | |
| 202 | Hotels |

Table 2a, (see page 12) represents the search values in the search look-up tables relating to “Category” on the centralised server. As can be seen from Table 2a, this search look-up table includes a search value “Accommodation” which has the category Id 102 and a search value “Hotels” which has the category Id 103. In order to link the categories in the respective search look-up tables on each server, a Category Look-up Routing Table is provided on the centralised server. An illustrative routing table is shown in Table 15 below.

TABLE 15
Category Look-up Routing Table

| Server Id | Category Id | Server Id | Category Id |
|---|---|---|---|
| Parent | Parent | Child | Child¹⁵ |
| 1001 | 102 | 1002 | 502 |
| 1001 | 103 | 1002 | 503 |
| 1001 | 103 | 1003 | 202 |

From Table 15 it will be seen that the centralised server (mainserver.com) with server Id 1001 has both the category Ids 102 and 103 linked as parents to category Ids 502 and 503 on the sydney.com server (1002) and category Id 202 on the bluemountain.com server (1003) respectively. With each of the search values in the search look-up tables employed in the distributed search engines, a distributed search can be performed directly from each distributed server. The user may typically nominate/restrict prior to searching the number of servers that will be searched in the distributed search.

In use, the data structure of FIG. 2 and the architecture of the data processing model shown in FIG. 1 will be completely opaque to the user. The user will be provided with a graphical user interface (GUI) similar to that illustrated in FIG. 3. In order to make a search query, the user must define two types of input. The user must select the kind of target item he/she is searching for, namely, websites, products or bulletin boards, in the described embodiment. The user must then select two or more search values using the buttons 34a, 34b to select a “Location”, button 34c to select a “Category” and button 34d to select a “Brand”. Alternatively, rather than defining the search criteria using the search look-up tables, the user can simply type in a keyword at 34e, in which case the search engine will produce a listing of all of the target items which include this key word, in a manner similar to that of a conventional search engine. It will be understood that the GUI of FIG. 3 is provided for illustrative purposes only, and that any suitable user interface may be employed. Indeed, with improvements in voice recognition software, the user interface may be voice operated if desired.

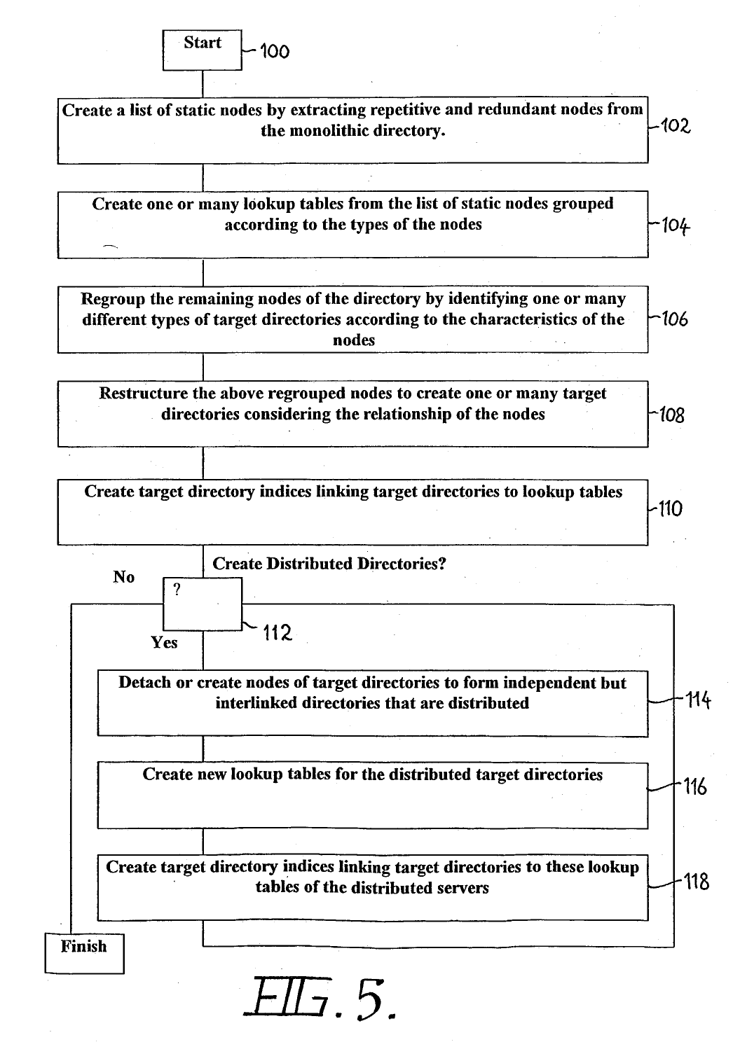

In order to further illustrate the difference between a conventional monolithic directory structure and the architecture of the preferred search engine of the present invention, a process for converting a conventional monolithic directory structure into the preferred architecture of the present invention will now be described with reference to FIG. 5. The first step at 102 is to extract all of the repetitive and redundant nodes from the monolithic directory and to create a list of these “static” nodes. These static nodes would typically be, for example, the broad headings and sub-headings such as those employed by Yahoo to categorise the websites in its directory structure. They are relatively unchanging, and are frequently repeated where the same website falls under several headings or sub-headings. From this list of static nodes, one or more look-up tables are created as step 104, grouped according to the types of nodes, for example, according to “location”, “category”, etc. The remaining nodes of the directory are then regrouped at step 106 by identifying one or many different types of target directories according to selected characteristics of the nodes. These regrouped nodes are then restructured at step 108 to create one or many target directories based on the relationship of the nodes to each other. At this point in the process, the monolithic directory has now been separated into two distinct sets of components, in accordance with the basic architecture of the present invention, namely, search look-up tables and the search target directories.

At step 110, the target directory indices are created by linking each of the target directories to the appropriate search look-up tables. If a decision is made at step 112 to create distributed directories, at step 114 some of the target directories may be detached or new target directories may be created to form independent but interlinked directories that are distributed on one or more remote servers. Each of the search engines in the remote servers will also be structured in a similar fashion, and therefore it will be necessary to create new search look-up tables for the distributed target directories at step 116. Finally, the appropriate target directory indices need to be created at step 118 linking the target directories in the distributed servers to the corresponding search look-up tables. From the above description of this conversion process, it will be apparent that the architecture of the search engine in accordance with the present invention is fundamentally different from that of a conventional monolithic directory based search engine.

From the above description of a preferred embodiment of the navigable search engine in accordance with the present invention it will be apparent that the described search engine provides a number of advantages over conventional search engines, including the following:

(i) the search engine facilitates vastly improved navigation in at least the following four ways:

navigating using different combinations of search values selected from the look-up tables. Thus, for example, it permits the user to begin her search by selecting the search values “Sydney” and “Hotels”, and then to modify the search midway by changing the search value “Hotels” to “Golf” or “Car Rentals”, etc.

navigating ‘vertically’ through a particular type of target search directories to search different sources of information without giving the same search criteria. For example, hotel listings by Suppliers (eg. pricing, rating, location, etc) as well as hotel listings by Customers (eg. backpackers, students, business traveller, etc) all relating to Sydney hotels.

navigating ‘horizontally’ through the various types of target search directories for different types of information given the same search criteria. For example, searching through websites, product catalogues, bulletin boards and advertisements all relating to Sydney hotels.

navigating to different servers in a distributed search engine architecture for more detailed and more relevant information. For example, searching for hotel websites in a particular locality, or obtaining hotel product offers available from a particular hotel chain.

(ii) the search engine is readily expandable and scalable as target directories can be added or subtracted, and existing target directories updated, as often as required without changing the architecture of the search engine;

(iii) relatively few people are required to maintain the search engine, and the supply of target directories can be delegated to industry groups that have a vested interest in providing accurate information;

(iv) it facilitates targeted advertising, whereby advertisers can pay to have their advertisements linked to particular search values or combinations of search values in order to target particular users;

(v) a distributed search engine architecture using clustered servers is readily facilitated because of the way the static components are separated from the dynamic components. This means less reliance on a centralised server as target directory information can be stored and maintained at multiple remote servers. It also facilitates delegation of search engine tasks and improves efficiency of search processing.

Numerous variations and modifications to the described embodiment of the search engine will suggest themselves to persons skilled in the computer programming arts, in addition to those already described, without departing from the basic inventive concepts. All such variations and modifications are to be considered with in the scope of the present invention, the nature of which is to be determined from the foregoing description and appended claims.

The claims defining the invention:

1. A navigable search engine architecture comprising:
a plurality of search look-up tables of predetermined search values that can be selected by a user to define search criteria;
a plurality of search target directories which consist of target items that a search may be targeted to find, each directory being organised with multi-level nodes, the nodes at each level having a heading that identifies a common characteristic of the target items linked to that node; and,
a plurality of target directory indices that are employed by the search engine to navigate through the target directories, each target directory index providing a link between each of said nodes in the target directories and related search values provided in said search look-up tables;
whereby, in use, when a user has defined the search criteria using said search values the search engine finds and lists the headings of the nodes in the target directories that are related to said search criteria, wherein the user can then select a heading to find individual target items that fit the search criteria.

2. A navigable search engine architecture as defined in claim 1, wherein the search values within each search look-up table are organised into a hierarchical tree structure.

3. A navigable search engine architecture as defined in claim 1, each said target directory is provided with the nodes and individual target items organised into a hierarchical tree structure wherein each node has a plurality of target items or other nodes linked to it.

4. A navigable search engine architecture as defined in claim 3, wherein each node and target item is provided with a unique identifier, and each target directory is provided with a target directory link table in which the links between “parents” and “children” within the hierarchical tree structure are defined using said identifiers.

5. A navigable search engine architecture as defined in claim 2, wherein each search value is provided with a unique identifier, and each search look-up table is provided with a search look-up link table in which the links between “parents” and “children” within the hierarchical tree structure are defined using said identifiers.

6. A navigable search engine architecture as defined in claim 1, wherein the search engine uses the search values and indices to create a directory list that lists all of the nodes in the target directories that are linked to the selected search values.

7. A navigable search engine architecture as defined in claim 1, wherein one or more of said plurality of search target directories are stored in remotely located servers so as to form a distributed search engine architecture.

8. A navigable search engine architecture as defined in claim 7, wherein each server in the distributed search engine architecture is provided with a unique identifier, and each server is provided with a target directory server link table in which the links between “parents” and “children” within the distributed hierarchical tree structure on that server are defined using said identifiers.

9. A navigable search engine architecture as defined in claim 8, wherein a target directory server link table is provided in which the links between servers in the distributed search engine architecture are defined.

10. A navigable search engine architecture as defined in claim 1, wherein one of the said search target directories includes a directory of advertisements, each advertisement in the directory being linked to related search values in a corresponding advertising directory index whereby, in use, advertisers can target their advertising based on the search criteria selected by a user of the search engine.

11. A search engine comprising:
means for selecting one or more search values from a plurality of search look-up tables of predetermined search values to define search criteria;
means for selecting one of a plurality of search target directories which consist of target items that a search may be targeted to find, each directory being organised with multilevel nodes, the nodes at each level having a heading that identifies a common characteristic of the target items linked to that node;
means for defining a plurality of target directories indices that are employed by the search engine to navigate through the target directories, each target directory index providing a link between each of said nodes in the target directories and related search values provided in said search look-up tables; and,
means for finding and listing the headings of the nodes in the target directories that are related to search criteria defined by a user using said search values, wherein the user can then select a heading to find the individual target items that fit the search criteria.

12. A search engine as defined in claim 11, further comprising means for searching through said plurality of target directory indices to locate relevant nodes in the target directories that are linked to the selected search values.

13. A search engine as defined in claim 12, further comprising means for creating a target directory list listing all of the relevant nodes in the target directories that are linked to the selected search criteria.

14. A method of using a search engine to navigate to a particular target in response to a search query, the method comprising:
providing a plurality of search target directories which consist of target items that a search may be targeted to find, each directory being organised with multilevel nodes, the nodes at each level having a heading that identifies a common characteristic of the target items linked to that node;
searching through a plurality of target directory indices to locate relevant nodes in the target directories, each target directory index providing a link between each of the nodes in the target directories and related search values that may be selected by the user from a plurality of search look-up tables; and,
listing the headings of the nodes in the target directories that are related to said search values, wherein the user can then select a heading to find individual target items that fit the search criteria.

15. A method of using a search engine as defined in claim 14, wherein said step of list the headings of the nodes involves creating a directory list that lists all of the nodes in the target directories that are linked to the selected search values.

16. A computer software program arranged, when loaded in a computer, to instruct the computer to operate in accordance with a search engine comprising:
means for selecting one or more search values from a plurality of search look-up tables of predetermined search values to define search criteria;
means for selecting one of a plurality of search target directories which consist of target items that a search may be targeted to find, each directory being organised with multi-level nodes, the nodes at each level having a heading that identifies a common characteristic of the target items linked to that node;
means for defining a plurality of target directories indices that are employed by the search engine to navigate through the target directories, each target directory index providing a link between each of said nodes in the target directories and related search values provided in said search look-up tables; and,
means for finding and listing the headings of the nodes in the target directories that are related to search criteria defined by a user using said search values, wherein the user can then select a heading to find the individual target items that fit the search criteria.
